(19) United States
(12) Patent Application Publication
(10) Pub. No.: US 2020/0164567 A1
(43) Pub. Date: May 28, 2020

(54) BLOW-MOLDED PLASTIC STRUCTURES

(71) Applicant: LIFETIME PRODUCTS, INC., Clearfield, UT (US)

(72) Inventor: Charles Monson, Clinton, UT (US)

(21) Appl. No.: 16/698,901

(22) Filed: Nov. 27, 2019

Related U.S. Application Data
(60) Provisional application No. 62/772,593, filed on Nov. 28, 2018.

(51) Int. Cl. B29C 49/54

(52) U.S. Cl. CPC B29C 49/54; B29L 2031/443

(57) ABSTRACT

A blow-molded plastic structure may include an inwardly extending portion with an undercut. The inwardly extending portion may be disposed in an outer surface of the blow-molded plastic structure and the undercut may be disposed in the inwardly extending portion. The structure may be formed by placing a tool in a mold, forming a parison of molten plastic, disposing the parison of molten plastic in the mold, closing the mold around the parison of molten plastic, inflating the parison, and creating an inwardly extending portion with an undercut with the tool during the blow-molding process. The tool used to create the undercut in a blow-molded plastic structure may include a base, one or more guides, and one or more fingers movable relative to the base between a molding position and a release position. The fingers may include an elongated body and an outwardly extending portion.

### CROSS-REFERENCE TO RELATED APPLICATIONS

The present application claims priority to and the benefit of U.S. Provisional Patent Application Ser. No. 62/772,593, entitled Blow-Molded Plastic Structures, which was filed on Nov. 28, 2018, and is hereby incorporated by reference in its entirety.

### BACKGROUND

### Field of the Invention

The present invention generally relates to structures that include at least a portion constructed from blow-molded plastic and, more particularly, to blow-molded plastic structures including an undercut.

### Description of Related Art

Blow-molding is a manufacturing process by which hollow plastic parts are formed. The blow-molding process typically begins with a hollow tube of molten plastic, which is commonly referred to as a parison. The parison is clamped into a mold and air is blown into the parison. The air pressure pushes the plastic into the faces of the mold so that the plastic takes the shapes of the mold. Once the plastic has cooled, the mold may be opened and the part may be ejected from the mold.

In greater detail, conventional blow-molding machines include a mold with two halves and the blow-molding process is initiated with the two mold halves spaced apart. The parison, or hollow tube of plastic, is extruded between the mold halves and then the mold halves are moved toward one another, often in a horizontal configuration or arrangement. The parison, which is disposed within the mold, is inflated with pressured gas, such as air, which is typically between about 60 psi and about 150 psi. The parison expands into contact with the inner surface of the molds and the plastic is formed into the desired shape. Thereafter, the air pressure may be reduced and the mold halves may be separated or opened to allow the blow-molded plastic article to be removed.

The blow-molding process is typically used to create hollow plastic structures such as bottles and containers. The blow-molding process may allow hollow plastic objects to be manufactured economically and in high volume. In addition, the blow-molding process may allow thin-walled objects to be quickly manufactured. Because blow-molded structures include a hollow interior portion and each mold half forms its own wall shape, a variety of different types of structures can be constructed using the blow-molding process.

The type and configuration of blow-molded plastic objects that may be formed may be limited by the hollow interior portion. Additionally, the type and configuration of blow-molded plastic objects that may be formed may be limited because pressurized air is required to stretch and push the plastic into the faces of the mold during the molding process. In addition, the outer wall thickness of a blow-molded plastic structure may be difficult to control because, as the object being manufactured is larger in size, the more the plastic may have to be stretched during the molding process.

### BRIEF SUMMARY

A need therefore exists for a blow-molded structure or blow-molding process that eliminates or diminishes the above-described disadvantages and problems.

One aspect is a structure that may be constructed from plastic. For example, the structure may be constructed from molded plastic. If desired, the structure may be constructed from blow-molded plastic.

Another aspect is the structure may be an article of furniture, such as a table or chair, water sports equipment, such as a kayak or paddleboard, a container, such as a bottle or cooler, an enclosure, such as a shed, and the like. The structure could also be component such as a table top, chair seat, chair back, a component of a kayak, a component of a paddleboard, a component of a cooler, a component of a shed, a component of playground equipment, and the like. Additionally, the structure could be other suitable objects, constructions, and the like such as a panel, section, and the like.

Still another aspect is a method of manufacturing or making a blow-molded plastic structure. The method may include forming a blow-molded plastic structure with one or more features or attributes.

Yet another aspect is a blow-molded plastic structure that may include an undercut. The undercut may be disposed in a cavity or void in an outer surface of the blow-molded plastic structure and the undercut may be an absence of material. For example, the blow-molded plastic structure may include an inwardly extending portion, which may include, for example, a cavity, void, pocket, indentation, depression, and the like. The inwardly expending portion may include a wall, such as a sidewall, and an undercut may be disposed in the wall. Thus, in an exemplary embodiment, an undercut may be disposed in a sidewall of the inwardly extending portion of a blow-molded plastic structure.

Still yet another aspect is a blow-molded plastic structure that may include an outer wall with an inwardly extending portion. The inwardly extending portion may extend into the hollow interior portion of the blow-molded plastic structure. The inwardly extending portion may include one or more walls, such as one or more sidewalls, and one or more undercuts may be formed in the walls. For instance, a first undercut may be disposed on a first side of the inwardly extending portion and a second undercut may be disposed on a second side of the inwardly extending portion. The inwardly extending portion and/or the undercuts may have a symmetrical or asymmetrical configuration depending, for example, upon the intended use of the structure.

Advantageously, the undercut may allow an object to be securely connected to the blow-molded plastic structure. For example, the undercut may allow a fastener or connector to be securely connected to the blow-molded plastic structure. The undercut may also facilitate connection of another object or article to the blow-molded plastic structure. For instance, the undercut may facilitate connection of a bracket or support to a blow-molded plastic structure. In addition, the undercut may allow blow-molded plastic structures to be securely connected. For example, the undercut may facilitate connection of a plurality of panels. Thus, the undercut may facilitate connection of a plurality of structures, such as a plurality of structures constructed from blow-molded plastic. For instance, the undercut may allow a plurality of panels, such as panels constructed from blow-molded plastic, to be connected.

In greater detail, the undercut may beneficially allow a fastener or other article to be securely connected to a blow-molded plastic structure. For example, the undercut may engage a portion of a fastener, such as a thread, edge, and/or protuberance. The engagement of a portion of the fastener with the undercut may create a secure connection. In addition, the engagement of a portion of the fastener with the undercut may help prevent unintentional removal of the fastener. Further, the undercut may be angled and, depending upon the angle of the undercut, a force applied to the fastener may result in more secure connection of the fastener to the blow-molded plastic structure. After reviewing this disclosure, one skilled in the art with appreciate that the undercut may have different shapes, sizes, configurations, and arrangements depending, for example, upon the intended use of the structure. For example, the undercut may include one or more surfaces disposed at an angle. The undercut may also be disposed in an angled surface. Thus, for example, the structure may include one or more surfaces and one or more of the surfaces may be disposed at an angle. Additionally, the undercut may include one or more surfaces and one or more of the surfaces may be disposed at an angle. If desired, the structure and/or undercut may include one or more angled surfaces depending, for example, upon the intended use of the structure, and/or the size, shape, configuration, and/or arrangement of the structure, which may be constructed from blow-molded plastic.

In an exemplary embodiment, the structure could be a chair seat constructed from blow-molded plastic and an inwardly extending portion with an undercut may be formed in the chair seat. The inwardly extending portion with the undercut may allow cushioning or padding to be securely connected to the chair seat. The inwardly extending portion with the undercut may allow other structures to be connected to the chair seat, such as a frame. In another exemplary embodiment, the structure could be a tabletop and an inwardly extending portion with an undercut may allow other structures to be connected to the tabletop, such as a frame. In another exemplary embodiment, the structure could be a panel and the inwardly extending portion with an undercut may allow a fastener to be securely connected to the panel. In still another exemplary embodiment, the structure could include a generally planar portion and an inwardly extending portion with an undercut may allow a fastener to be securely connected to the structure. If desired, the inwardly extending portion may form or be part of a depression (which may also be referred to as a tack-off). The depression may extend into the hollow interior portion or a volume of the structure. The inwardly extending portion with an undercut may also have a similar size, shape, configuration, and/or arrangement to one or more adjacent depressions or other features. This may allow a structure with more uniform properties or characteristics to be created.

A further aspect is a blow-molded plastic structure that may include an inwardly extending portion with an undercut that is integrally formed during a molding process as part of a unitary, one-piece structure or construction. A unitary, one-piece, blow-molded plastic structure including an inwardly extending portion with an undercut may facilitate use of the structure. For example, the blow-molded plastic structure including an inwardly extending portion with an undercut may allow the structure to be used in different configurations, arrangements, environments, and the like. The unitary, one-piece, blow-molded plastic structure with an inwardly extending portion and an undercut may also increase the range of capabilities and/or uses of the structure. One skilled in the art, after reviewing this disclosure, will appreciate that the blow-molded plastic structure including an inwardly extending portion with an undercut may have a variety of different uses and functions. Additionally, one skilled in the art, after reviewing this disclosure, will appreciate that the blow-molded plastic structure including an inwardly extending portion with an undercut may have a variety of different features, aspects, characteristics, and the like. Further, one skilled in the art, after reviewing this disclosure, will appreciate that the blow-molded plastic structure including an inwardly extending portion with an undercut may have a variety of different shapes, sizes, configurations, and/or arrangements depending, for example, upon the intended use of the structure.

Another further aspect is a blow-molded plastic structure that may include an inwardly extending portion with an undercut that forms at least a portion of a receiving portion. The receiving portion may be disposed between the undercut and a surface, such as an upper surface, of the inwardly extending portion. For example, the receiving portion may be disposed between an upper surface of the undercut and an upper surface of the inwardly receiving portion. The receiving portion may also be formed by a portion of the undercut, a portion of a sidewall of the inwardly extending portion, and/or an upper surface of the inwardly extending portion. The receiving portion may be sized and configured to receive a portion of a fastener or connector, if desired.

A still further aspect is a blow-molded plastic structure that may include an inwardly extending portion with an undercut and the undercut may be disposed at an angle. For example, in an exemplary embodiment, the undercut may include a surface that is disposed generally parallel to or at an angle relative to a lower surface of the structure and/or an upper surface of the structure. In another exemplary embodiment, the undercut may include a surface that is disposed generally parallel to or at an angle relative to a surface, such as an upper surface, of the inwardly extending portion. In still another exemplary embodiment, the undercut may include a surface that is disposed at an angle relative to a sidewall of the inwardly extending portion. For example, the undercut may include a surface that is disposed generally perpendicular or at an angle relative to a wall of the inwardly extending portion.

Yet another further aspect is a blow-molded plastic structure that may include an inwardly extending portion with an undercut and the undercut may include a surface that is generally flat or planar. The undercut may also include a surface that is rounded, curved, or the like. Additionally, the undercut may include one or more indentations, depressions, receiving portions, and the like. As indicated above, the undercut may also be at least partially disposed in one or more indentations, depressions, receiving portions, and the like.

Still yet another further aspect is a blow-molded plastic structure that may include an inwardly extending portion with an undercut and the undercut may include a surface that is disposed generally perpendicular or at an angle relative to a sidewall of the inwardly extending portion. For example, the surface may be disposed at an acute angle relative to a sidewall of the inwardly extending portion. For instance, the undercut may include a surface that is disposed at an angle of about ninety degrees (90°) or less relative to a sidewall of the inwardly receiving portion. The undercut may also include a surface that is disposed at an angle of about eighty degrees (80°) or less relative to a sidewall of the inwardly receiving portion, an angle of about seventy degrees (70°) or less relative to a sidewall of the inwardly receiving portion, an angle of about sixty degrees (60°) or less relative to a sidewall of the inwardly receiving portion, an angle of about fifty degrees (50°) or less relative to a sidewall of the inwardly receiving portion, an angle of about forty degrees (40°) or less relative to a sidewall of the inwardly receiving portion, an angle of about thirty depress (30°) or less relative to a sidewall of the inwardly receiving portion, an angle of about twenty degrees (20°) or less relative to a sidewall of the inwardly receiving portion, an angle of about ten degrees (10°) or less relative to a sidewall of the inwardly receiving portion. The angle of the surface of the undercut may be measured, for example, relative to an upper portion of the sidewall of the receiving portion. The angle of the surface of the undercut may also be measured relative to a lower portion of the sidewall of the receiving portion.

Another aspect is blow-molded plastic structure that may include an inwardly extending portion with an undercut and the undercut may include an angled surface that extends towards or is angled towards an outer surface of the structure. The angled surface of the undercut may facilitate secure engagement of a fastener, connector, or other object with the blow-molded plastic structure. For instance, the undercut may include a surface that is disposed towards the outer surface of the structure and the surface may be disposed at an angle of about two degrees (2°) or more, about four degrees (4°) or more, about six degrees (6° or more, about eight degrees (8°) or more, about ten degrees (10°) or more. It will be appreciated that the angle of the surface of the undercut may impact the ease at which a fastener or connector may be attached or disconnected from the structure. It will also be appreciated that the angle of the surface of the undercut may be disposed at other suitable angles depending, for example, upon the intended use of the structure. It will be further appreciated that the undercut may have other suitable shapes, sizes, configurations, and/or arrangements depending, for example, upon the intended use of the structure.

Still another aspect is a blow-molded plastic structure that may include an inwardly extending portion with an undercut and a surface of the undercut may be disposed at a sharp angle. For example, the undercut may include an edge, corner, or transition that is sharp or abrupt. The transition may be disposed at an angle of less than about ninety degrees (90°). For instance, the transition may be disposed at an angle of about eighty degrees (80°) or less, about seventy degrees (70°) or less, about sixty degrees (60°) or less, about fifty degrees (50°) or less, about forty degrees (40°) or less, about thirty degrees (30°) or less, about twenty degrees (20°) or less, or about ten degrees (10°) or less. The distinct edge or transition of the undercut may facilitate attachment of a fastener, connector, or other object to the blow-molded plastic structure. In addition, the undercut may help form and/or be disposed at least proximate a relatively large receiving portion. For example, the undercut may help form a receiving portion at least partially disposed between the undercut and the inner surface of the inwardly receiving portion. The undercut may also provide a relatively large area of contact or engagement, which may further facilitate attachment of a fastener, connector, or other object to the blow-molded plastic structure. The large receiving portion, the large surface area, and/or the sharp angle or transition may facilitate secure connection of a fastener, connector, or other object to the blow-molded plastic structure.

Yet another aspect is a method of forming an undercut in a blow-molded plastic structure. The method may include forming an inwardly extending portion with an undercut in an outer surface of a blow-molded plastic structure. For example, a first undercut may be disposed on a first side of the inwardly extending portion and a second undercut may be disposed on a second side of the inwardly extending portion. The inwardly extending portion may be formed by a tool with a base and one or more fingers. The fingers may be movable or slidable relative to the base and the base may include a guide, which may help control movement of the fingers. The fingers may be disposed at an angle and the guide may include a generally wedge-shaped portion disposed between the fingers. The distal ends of the fingers may include outwardly extending portions and the outwardly extending portions may be used to form one or more undercuts. For example, in a molding position, the distal ends of the fingers may be disposed a first distance away from the base of the tool and the outermost portions of the outwardly extending portions of the fingers may be spaced a first distance apart. When the blow-molded plastic structure is formed, plastic may envelop or encircle the ends of the fingers and/or a portion of the guide, such as the wedge-shaped structure. After the inwardly extending portion with the undercuts is formed, the blow-molded plastic structure may be moved away from the face of the mold and the fingers may move inwardly and at an angle relative to the face of the mold. When the blow-molded plastic structure has moved a distance away from the face of the mold, the distal ends of the fingers may be disposed a second distance away from the base of the tool and the outermost portions of the outwardly extending portions of the fingers may be spaced a second distance apart. When the distance separating the outermost portions of the outwardly extending portions of the fingers is less than the distance separating the innermost portions of the undercuts, the blow-molded plastic structure may be removed or released from the mold.

Still yet another aspect is a method of manufacturing an undercut in a blow-molded plastic structure. The method may include placing a tool in a portion of a mold and the tool may be used to form the undercut. The method may also include forming or disposing a plastic parison within a mold and closing the mold around the parison. The parison may be inflated with a gas such as pressurized air. The undercut may be formed by the tool and then the molded structure with the undercut may be released or removed from the mold.

A further aspect is a tool that may be used to create an undercut in a blow-molded plastic structure. The tool, for example, may create an inwardly extending portion with an undercut. The tool may include a base and a surface of the base may help form a portion of the blow-molded plastic structure. For instance, an upper surface of the base may be generally aligned with a portion of the mold and the upper surface of the base may help form a portion of the blow-molded plastic structure. The base may include a first guide, such as a pathway or opening, and a first finger may be at least partially disposed in the first guide. The base may also include a second guide, such as a pathway or opening, and a second finger may be at least partially disposed in the second guide. The first guide may help control movement of the first finger relative to the base and the second guide may help control movement of the second finger relative to the base. The base may include one or more inwardly extending projection, which may also be referred to as one or more guides, and the inwardly extending projection may have a generally wedge-shaped configuration and/or the guides may be disposed in a generally wedge-shaped configuration. The guides may be sized and configured to allow the fingers to move between one or more positions relative to the base. For example, the guides may be sized and configured to allow the fingers to be disposed in a molding position and a release position. When the fingers are disposed in the molding position, the distal ends of the fingers may be disposed a first distance away from the base and the distal ends of the fingers may include outwardly extending portions. In the molding position, the outer portion of the outwardly extending portions may be separated by a distance and the outwardly extending portions may be used to form at least a portion of the undercut. When the fingers are disposed in the release position, the ends of the fingers may be spaced apart from the base of the mold by a second distance and the outmost portions of the outwardly extending portions of the fingers may be separated by a second distance. When the distance separating the outmost portions of the outwardly extending portions of the fingers is less than a distance separating the innermost portion of the inwardly extending portion of the blow-molded plastic structure, the structure may be removed or released from the tool.

Another aspect is a blow-molded plastic structure that may be constructed using a blow-molding process, the blow-molded plastic structure may include an outer surface, the blow-molded plastic structure may include an inwardly extending portion disposed in the outer surface, and an undercut may be disposed in the inwardly extending portion. The undercut may include a surface and an angled portion, the angled portion may be disposed at an angle, such as an acute angle, relative to the surface, and the angled portion may form at least a portion of an edge of the undercut. The undercut may form at least a portion of a receiving portion. The receiving portion may be at least partially formed or disposed between an upper surface of the undercut and an upper surface of the inwardly extending portion. The outer surface, the inwardly extending portion, and the undercut may be integrally formed as part of a unitary, one-piece structure during the blow-molding process.

Still another aspect is a method of manufacturing a blow-molded plastic structure using a blow-molded process, and the method may include placing a tool in a portion of a mold, forming a parison of molten plastic, disposing the parison of molten plastic in the mold, closing the mold around the parison of molten plastic, inflating the parison, and creating an inwardly extending portion with an undercut with the tool. The method may include releasing the inwardly extending portion with the undercut from the tool by moving the tool from a molding position to a release position. The method may include releasing the molded plastic structure from the mold and releasing the inwardly extending portion with the undercut from the tool. If desired, the method may include concurrently releasing the molded plastic structure from the mold and releasing the inwardly extending portion with the undercut from the tool. The method may include creating a receiving portion disposed between an upper surface of the undercut and an upper surface of the inwardly extending portion. The method may include creating an edge of the undercut and the edge may be disposed at an acute angle relative to a surface of the undercut. For example, the acute angle may be disposed at an angle less than about sixty degrees (60°), less than about fifty degrees (50°), less than about forty degrees (40°), less than about thirty degrees (30°), less than about twenty degrees (20°), or less than about ten degrees (10°) relative to a surface, such as the surface of the undercut.

Yet another aspect is a tool that may be used to create an undercut in a blow-molded plastic structure constructed using a blow-molded process, the tool may include a base, a first guide at least partially disposed in the base, a second guide at least partially disposed in the base, a first finger at least partially disposed in the first guide, the first finger being movable relative to the base between a molding position and a release position, the first finger including an elongated body and an outwardly extending portion, and a second finger at least partially disposed in the second guide, the second finger being movable relative to the base between a molding position and a release position, the second finger including an elongated body and an outwardly extending portion. When the first finger and the second finger are disposed in the molding position, an upper surface of the outwardly extending portion of the first finger and an upper surface of the outwardly extending portion of the second finger may be generally aligned in the same plane; and when the first finger and the second finger are disposed in the release position, the upper surface of the outwardly extending portion of the first finger and the upper surface of the outwardly extending portion of the second finger may be generally aligned in the same plane. When the first finger and the second finger are disposed in the molding position, an upper surface of the outwardly extending portion of the first finger and an upper surface of the outwardly extending portion of the second finger may be disposed a first distance from the base; and when the first finger and the second finger are disposed in the release position, the upper surface of the outwardly extending portion of the first finger and the upper surface of the outwardly extending portion of the second finger may be disposed a second distance from the base, the second distance may be greater than the first distance. The first finger may move along a first axis that is disposed at an angle relative to the base and the second finger may move along a second axis that is disposed at an angle relative to the base, the angle of the first axis relative to the base may be generally the same as the angle of the second axis relative to the base. The outwardly extending portion of the first finger may be disposed a first distance from the outwardly extending portion of the second finger when the first finger and the second finger are in the molding position; the outwardly extending portion of the first finger may be disposed a second distance from the outwardly extending portion of the second finger when the first finger and the second finger are in the release position; and the second distance may be smaller than the first distance to allow the outwardly extending portion of the first finger and the outwardly extending portion of the second finger to be removed from the undercut formed in the blow-molded plastic structure.

These and other aspects, features and advantages of the present invention will become more fully apparent from the following brief description of the drawings, the drawings, the detailed description of preferred embodiments and appended claims.

### BRIEF DESCRIPTION OF THE DRAWINGS

The appended drawings contain figures of exemplary embodiments to further illustrate and clarify the above and other aspects, advantages and features of the present invention. It will be appreciated that these drawings depict only exemplary embodiments of the invention and are not intended to limit its scope. Additionally, it will be appreciated that while the drawings may illustrate preferred sizes, scales, relationships and configurations of the invention, the drawings are not intended to limit the scope of the claimed invention. The invention will be described and explained with additional specificity and detail through the use of the accompanying drawings in which:

FIG. 1A is an upper perspective view of an exemplary chair seat, illustrating an exemplary tool in a molding position;

FIG. 1B is an upper perspective view of the exemplary chair seat shown in FIG. 1A, illustrating the tool in an at least partially released position;

FIG. 1C is an upper perspective view of the exemplary chair seat shown in FIG. 1A, illustrating the tool in a release position and separated from the chair seat;

FIG. 2A is cross-sectional side view of an exemplary mold, illustrating an exemplary tool in a molding position and two halves of a mold;

FIG. 2B is a cross-sectional side view of the exemplary mold shown in FIG. 2A, illustrating a blow-molded plastic structure formed in the mold and the exemplary tool in the molding position;

FIG. 2C is a cross-sectional side view of the exemplary mold shown in FIG. 2A, illustrating the blow-molded plastic structure at least partially released from the mold and the tool disposed in an at least partially released position;

FIG. 2D is a cross-sectional side view of the exemplary mold shown in FIG. 2A, illustrating the blow-molded plastic structure released from the mold and the tool disposed in the release position;

FIG. 3A is cross-sectional side view of an exemplary mold, illustrating an exemplary tool in a molding position and two halves of a mold;

FIG. 3B is a cross-sectional side view of the exemplary mold shown in FIG. 3A, illustrating a blow-molded plastic structure formed in the mold and the exemplary tool in the molding position;

FIG. 3C is a cross-sectional side view of the exemplary mold shown in FIG. 3A, illustrating the blow-molded plastic structure at least partially released from the mold and the tool disposed in an at least partially released position;

FIG. 3D is a cross-sectional side view of the exemplary mold shown in FIG. 3A, illustrating the blow-molded plastic structure released from the mold and the tool disposed in the release position;

FIG. 4A is an upper perspective view of an exemplary tool, illustrating the tool in a molding position;

FIG. 4B is a lower perspective view of the exemplary tool shown in FIG. 4A, illustrating the tool in the molding position;

FIG. 5A is an upper perspective view of an exemplary tool, illustrating the tool in a release position;

FIG. 5B is a lower perspective view of the exemplary tool shown in FIG. 4A, illustrating the tool in the release position;

FIG. 6A is a perspective view of an inner face of a finger of an exemplary tool;

FIG. 6B is a perspective view of an outer face of the finger of the exemplary tool shown in FIG. 6A;

FIG. 7A is an upper perspective view of a base of an exemplary tool;

FIG. 7B is a lower perspective view of the base of the exemplary tool shown in FIG. 7A;

FIG. 8 is a perspective view of an exemplary chair seat including a blow-molded plastic portion with a plurality of inwardly receiving portions with an undercut and an exemplary structure, such as a chip or clip, with a plurality of engaging portions that are sized and configured to inserted into the inwardly receiving portions;

FIG. 9 is an enlarged perspective view of a portion of the exemplary chair seat shown in FIG. 8;

FIG. 10 is another enlarged perspective view of a portion of the exemplary chair seat shown in FIG. 8; and

FIG. 11 is a flow diagram illustrating an exemplary method of producing a blow-molded plastic structure including an undercut.

### DETAILED DESCRIPTION OF SOME EMBODIMENTS

The following exemplary embodiments are generally described in connection with blow-molded plastic structures such as chair seats. The principles of the present invention, however, are not limited to chair seats. In particular, the principles of the present invention may be implemented in other articles of furniture and in other structures that include blow-molded plastic components. In addition, it will be understood that, with the benefit of the present disclosure, the structures can have a variety of shapes, sizes, configurations, and arrangements. Moreover, the invention disclosed herein and components thereof may be successfully used in connection with other types of structures such as furniture (e.g., tables, picnic tables, etc.), objects (e.g., storage sheds, deck boxes, coolers, garden boxes, playground equipment, sporting goods, water sports equipment, etc.), and the like.

To assist in the description of exemplary embodiments shown in the accompanying figures, words such as top, bottom, front, rear, right and left may be used. The accompanying figures may be, but are not necessarily, drawn to scale. It will further be appreciated the structures can be disposed in a variety of desired positions or orientations, and used in numerous locations, environments and arrangements. A detailed description of some exemplary embodiments of the structures, such as chair seats, now follows.

As shown in the accompanying figures, an exemplary chair seat 10 may be constructed from blow-molded plastic. The chair seat 10 may include an upper portion 12, a lower portion 14, and an outer boundary 16. The upper portion 12 may be spaced apart from the lower portion 14 by a distance. The chair seat 10 may also include a hollow interior portion 18 disposed between the upper portion 12 and the lower portion 14.

The chair seat 10 may further include one or more sides, corners, and ends. The chair seat 10, including the upper portion 12, the lower portion 14, the hollow interior portion 18, the sides, the corners, and/or the ends, may be integrally formed as part of unitary, one-piece structure during the blow-molding process. It will be appreciated that the chair seat 10 may have a variety of suitable shapes, sizes, configurations, and/or arrangements depending, for example, upon the intended use of the chair seat. It will also be appreciated that the chair seat 10 may be constructed using various materials and may include one or more features, aspects, and the like.

Although not shown in the accompanying figures, the chair may include one or more support structures or legs, which may be sized and configured to support the chair seat above a surface such as the floor or ground. The support structures may include one or more supports and the support structures may be movable between a use position and a collapsed or storage position. It will be appreciated that the chair may include any suitable number of support structures and/or legs depending, for example, upon the intended use of the chair. It will also be appreciated that the support structures and/or legs may have different shapes, sizes, configurations, and/or arrangements depending, for example, upon the type or intended use of the chair.

The chair may include a frame that is connected to the chair seat and the support structures. The frame may facilitate movement of the support structures between the use and the collapsed or storage positions. The frame may have different shapes, sizes, configurations, and/or arrangements depending, for example upon the type or intended use of the chair. It will be appreciated that the frame is not required and the chair may have other components, features, aspects, characteristics and the like, if desired.

The chair seat 10 may be covered by one or more layers such as a cover, padding, and the like. The chair seat 10 may include one or more recesses 20 and the recesses may be sized and configured to receive padding material. An exemplary embodiment of a chair including one or more layers of padding and a covering is shown in U.S. patent application Ser. No. 15/373,457, filed Dec. 8, 2016 (U.S. Publication No. US 2017-0164746), which is incorporated by reference in its entirety. It will be appreciated with the benefit of the present disclosure that the chair may include any suitable number of components and the components may have various sizes, shapes, configurations, and arrangements depending, for example, upon the intended use of the chair. It will further be appreciated that the chair may include other components, features, aspects, characteristics and the like, if desired; but none of the features, aspects or components may be required.

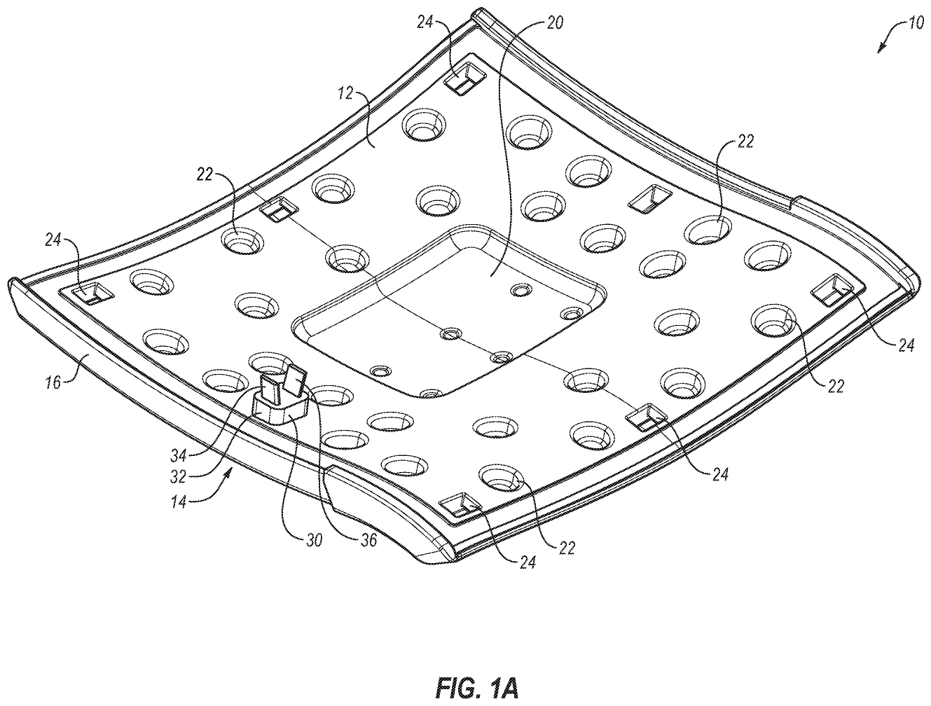

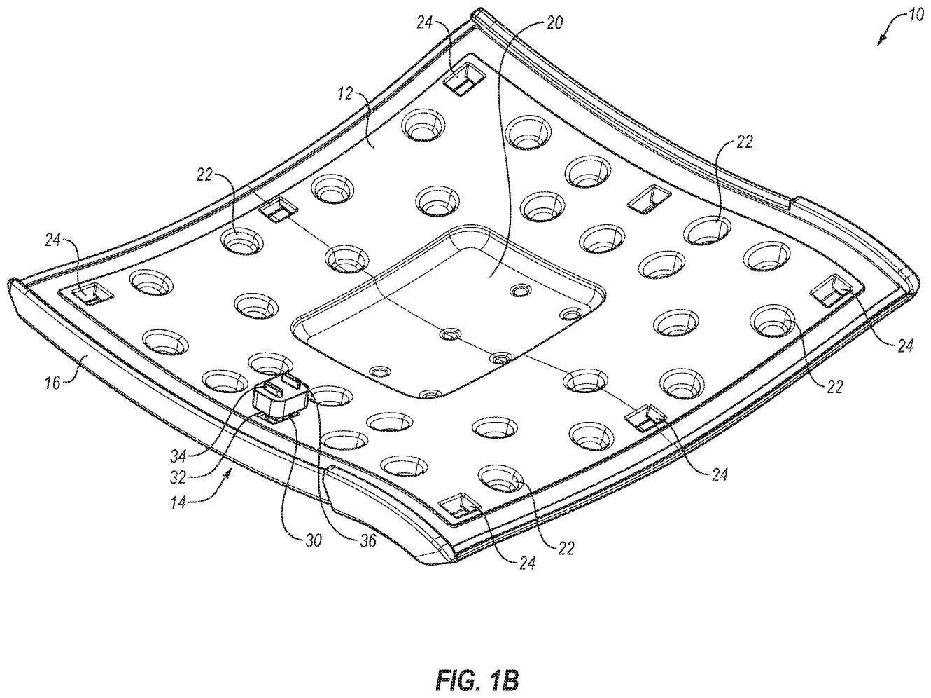

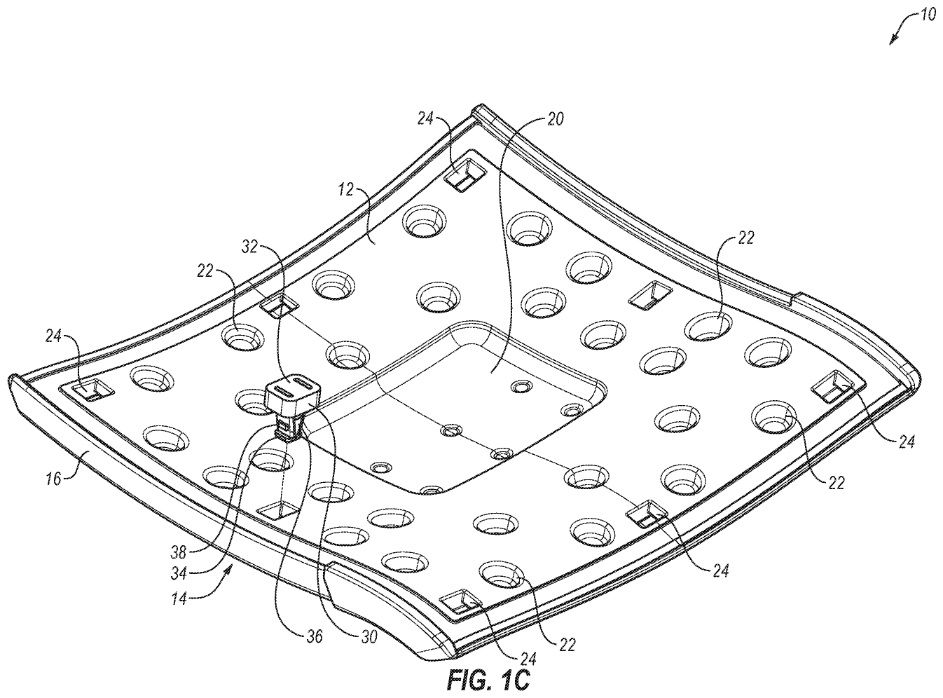

As shown in FIGS. 1A-1C, the chair seat 10 may include one or more depressions 22, which may also be referred to as tack-offs. The depressions 22 may be sized, shaped, configured, and arranged to provide increased strength, stiffness, and/or rigidity to the chair seat 10. The depressions 22 may cover a majority, substantially all or the entirety of the lower portion 14 of the chair seat 10. In addition, the depressions 22 may have a generally uniform shape, size, configuration, and arrangement. The depressions 22 may further have an elongated shape that is aligned with an axis and the depressions may be aligned in a series of rows and/or columns that extend along the length and/or width of the chair seat 10. Additionally, the depressions 22 in adjacent rows and columns may be aligned and/or offset, and the distance between adjacent depressions in the rows and columns may be generally the same. For example, the distance between adjacent depressions 22 in each row and/or column may be generally constant or the same. The distance between adjacent rows and columns may also be generally constant or the same.

The depressions 22 may be used to create a chair seat 10 with generally uniform characteristics or qualities. For example, if the depressions 22 are consistently spaced, that may allow the upper portion 12 of the chair seat to be uniformly supported. In addition, if the depressions 22 are separated by a generally constant distance, which may be measured from a center of one depression to a center of an adjacent depression, that may create a chair seat 10 with more uniform characteristics or qualities. The distance between adjacent depressions 22 may be measured longitudinally, laterally, or at an angle depending, for example, upon the arrangement of the depressions.

The depressions 22 may also be disposed in a pattern and the depressions may be generally aligned and/or disposed in predetermined locations within the pattern. The pattern may include, for example, a number of rows and/or columns of depressions 22. The rows may be disposed along a length of the chair seat 10 and the columns may extend along a width of the chair seat. The depressions 22 may also be disposed in other suitable forms and patterns, and may have other shapes, sizes, configurations and arrangements, depending, for example, upon the intended use of the chair.

The depressions 22 may extend inwardly into the hollow interior portion 18 of the blow-molded plastic structure, such as the chair seat 10. The depressions 22 may have a generally conical, curved, domed, elongated, or other suitable shape. The depressions 22 may be integrally formed during the blow-molding process as part of a unitary, one-piece structure. Thus, for example, the chair seat 10 and the depressions 22 may be integrally formed during the blow-molding process as part of a unitary, one-piece structure.

The chair seat 10 may include one or more inwardly extending portions 24, as shown in FIGS. 1A-1C. The chair seat 10 shown in the accompanying figures includes eight (8) inwardly extending portions 24 and the inwardly extending portions may have a generally rectangular configuration. In particular, the inwardly extending portions 24 may be disposed in an upper surface 12 of the chair seat 10, and the inwardly extending portions may be sized and configured to allow something to be attached to the chair seat, such as padding and/or a covering. The inwardly extending portions 24 may include an undercut 26 that is integrally formed during the blow-molding process as part of a unitary, one-piece structure. After reviewing this disclosure, one skill in the art will appreciate that the inwardly extending portions 24 may have other suitable shapes, sizes, configurations, and/or arrangements.

In contrast to the depressions 22, the inwardly extending portions 24 with the undercut 26 cannot be formed with traditional blow-molding techniques. Instead, a tool 30 allows the inwardly extending portion 24 with an undercut 26 to be formed during the blow-molding process. The exemplary tool 30 shown in FIGS. 1A-1C may include a base 32, a first finger 34, and a second finger 36. The first and second fingers 34, 36 may be movable between a molding position in which the blow-molded structure may be formed and a release position in which the blow-molded structure may be released from the tool 30. As shown in the accompanying figures, the first finger 34 may include a stop 38 and the second finger 36 may include a stop 40, and the stops may help control movement of the fingers. For example, the stops 38, 40 may help position the fingers 34, 36 in the molding position and/or the release position. The fingers 34, 36 may also include more than one stop, which may help position the fingers in the molding position and/or the release position. The first and second fingers 34, 36 may include an end 42, 44, such as a distal end, that extends outwardly relative to an upper surface 46 of the base 32. That is, the first finger 34 may include the stop 38 and the end 42, and the second finger 36 may include the stop 40 and the end 44. A portion of the first and second fingers 34, 36, which may include the distal ends, such as the ends 42, 44, may be sized and configured to contact or touch the plastic during the blow-molding process. Thus, the ends 42, 44 of the fingers 34, 36 may help form the plastic into the desired shape during the molding process. The first and second fingers 34, 36 may also include another end 48, 50, such as a proximal end, and the proximal ends of the fingers may be disposed at least proximate a lower surface 52 of the base 32. That is, the first finger 34 may include the end 42, which may be the distal end, and the end 48, which may be the proximal end; and the second finger 36 may include the end 44, which may be the distal end, and the end 50, which may be the proximal end. The tool 30, the base 32, and/or the fingers 34, 36 may be connected to a device, such as a motor, cam, piston, driver, and the like, and the device may help control movement of one or more of the fingers. For example, the device may move the first finger 34 and/or the second finger 36 between the molding position and the release position.

The fingers 34, 36 may include outwardly extending portions and the outwardly extending portions may be sized and configured to form the undercut 26 in the inwardly extending portions. As shown in the accompanying figures, the blow-molded plastic structure, such as the chair seat 10, may include one or more undercuts 26 and/or one or more inwardly extending portions 24. For example, the first finger 34 may include an outwardly extending portion 54 and the outwardly extending portion may be sized and configured to form a first undercut 58 in an inwardly extending portion 62. The second finger 36 may include an outwardly extending portion 56 and the outwardly extending portion may be sized and configured to form a second undercut 60 in an inwardly extending portion 64. In greater detail, an outwardly extending portion 54, 56 may be disposed at the distal end 42, 44 of each finger 34, 36 and the outwardly extending portions may extend in opposing directions. For example, in the molding position, the outwardly extending portions 54, 56 may extend in opposite directions and the outwardly extending portions may be disposed in generally the same plane. The outwardly extending portions 54, 56 may include a generally planar first surface 66 and a generally planar second surface 68 that are separated by a distance. The first and second generally planar surfaces 66, 68 may be generally aligned in parallel planes. The first and second generally planar surfaces 66, 68, however, do not have to be aligned or disposed in generally parallel planes. For example, the first and second generally planar surfaces 66, 68 could be disposed at an angle depending, for example, upon the type of undercut to be formed. The outwardly extending portions 54, 56 may also include an outer edge 70, 72 or wall that extends between the first and second surfaces. Thus, the outwardly extending portion 54 of the first finger 34 may include the first surface 66, the second surface 68, and the outer edge 70. The outwardly extending portion 56 of the second finger 36 may include the first surface 66, the second surface 68, and the outer edge 72. As discussed above, the first and second surfaces 66, 68 of the outwardly extending portions 54, 56 may be generally aligned, for example, when the fingers 34, 36 are disposed in the same positions. In addition, the outer edges 70, 72 of the outwardly extending portions 54, 56 may be generally aligned in parallel planes. The surfaces 66, 68 and/or outer edges 70, 72 may also be disposed at other suitable angles and may have other shapes, sizes, configurations, or arrangements depending, for example, upon the structure to be constructed from blow-molded plastic.

When the tool 30 is disposed in the molding position, an upper surface 74 of the first finger 34, an upper surface 76 of second finger 36, an upper surface 78 of the outwardly extending portion 54, and/or an upper surface 80 of the outwardly extending portion 56 may be generally aligned and/or disposed in the same plane. The upper surfaces 74, 76 of the first and second fingers 34, 36, and/or the upper surfaces 78, 80 of the outwardly extending portions 54, 56 may also be aligned with a portion of the base 32. For example, the upper surfaces 74, 76 of the first and second fingers 34, 36, and/or the upper surfaces 78, 80 of the outwardly extending portions 54, 56 may also be aligned with a portion of the base 32, such as a guide 82. If desired, the upper surfaces 74, 76 of the first and second fingers 34, 36, and/or the upper surfaces 78, 80 of the outwardly extending portions 54, 56 may also be aligned with an upper surface 84 of the guide 82. The guide 82 may have a generally wedge or triangular-shaped configuration and the upper surfaces 74, 76 of the first and second fingers 34, 36 and/or the upper surfaces 78, 80 of the outwardly extending portions 54, 56 may be generally aligned with the upper surface 84 of the guide 82. In the molding position, the outer surfaces of the fingers 34, 36 proximate the base may be separated by a first distance D₁, the outer surfaces of the fingers proximate the outwardly extending portions may be separated by a second distance D₂, and the outermost ends or edges of the outwardly extending portions of the fingers may be separated by a third distance D₃. The first distance D₁ may be greater than the second distance D₂ or the third distance D₃, and this portion of the tool 30 may form a base of the inwardly extending portion 24 during the molding process. The second distance D₂ may be smaller than the first distance D₁ and the third distance D₃, and the second distance may help identify the narrowest portion of the inwardly extending portion 24. The third distance D₃ may be smaller than the first distance D₁ and larger than the second distance D₂, and the third distance may help identify the undercut.

When the blow-molded structure is being formed, the plastic may contact and be disposed about an upper, exterior portion of the first and second fingers 34, 36, the outwardly extending portions 54, 56, and a portion of the base 32, such as a portion of the guide 82 and/or the upper surface 46 of the base. FIG. 1A shows the tool 30 in the molding position and disposed in an inwardly extending portion 24 of the chair seat 10, after the chair seat has been molded. FIG. 1B shows the tool 30 at least partially disposed in the release position with the fingers 34, 36 moved relative to the base 32. FIG. 1C shows the tool 30 spaced apart from the molded chair seat 10 and the tool in the release position. Advantageously, the tool 30 may allow the inwardly extending portion 24 with the undercut 26 to be created during the blow-molding process. In addition, the structure, such as the chair seat 10, may be removed from the tool 30, and/or the tool may be removed from the structure, after the structure is formed without any, or substantially without any, deformation of the molded plastic structure. Significantly, the undercut 26 can include planar surfaces and/or sharp angles, which may facilitate secure connection for components, such as fasteners, connectors, or other objects, to a blow-molded plastic structure, such as the chair seat 10.

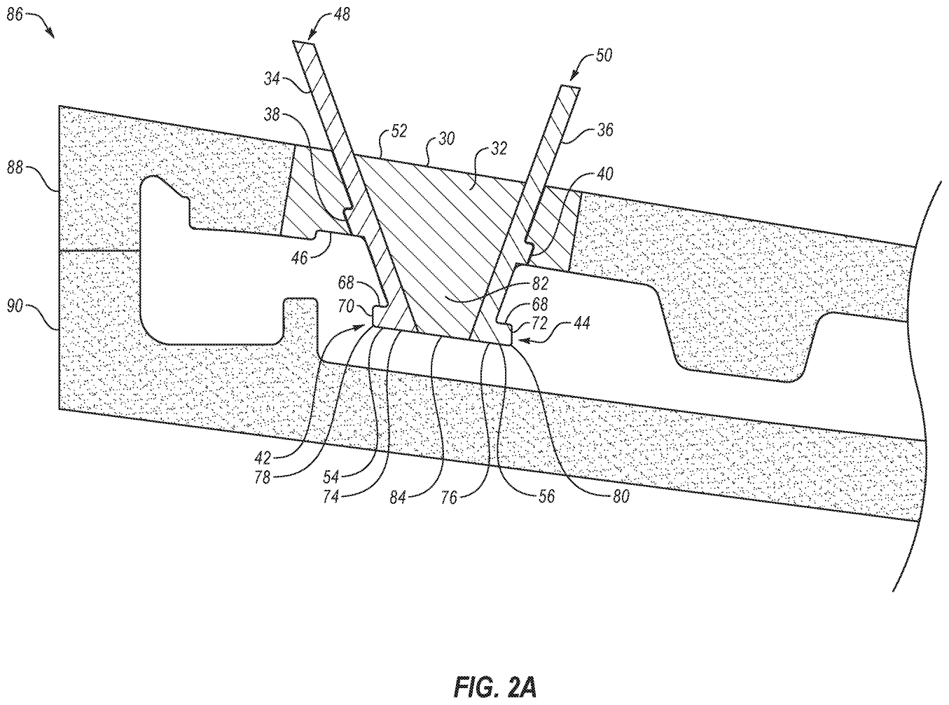

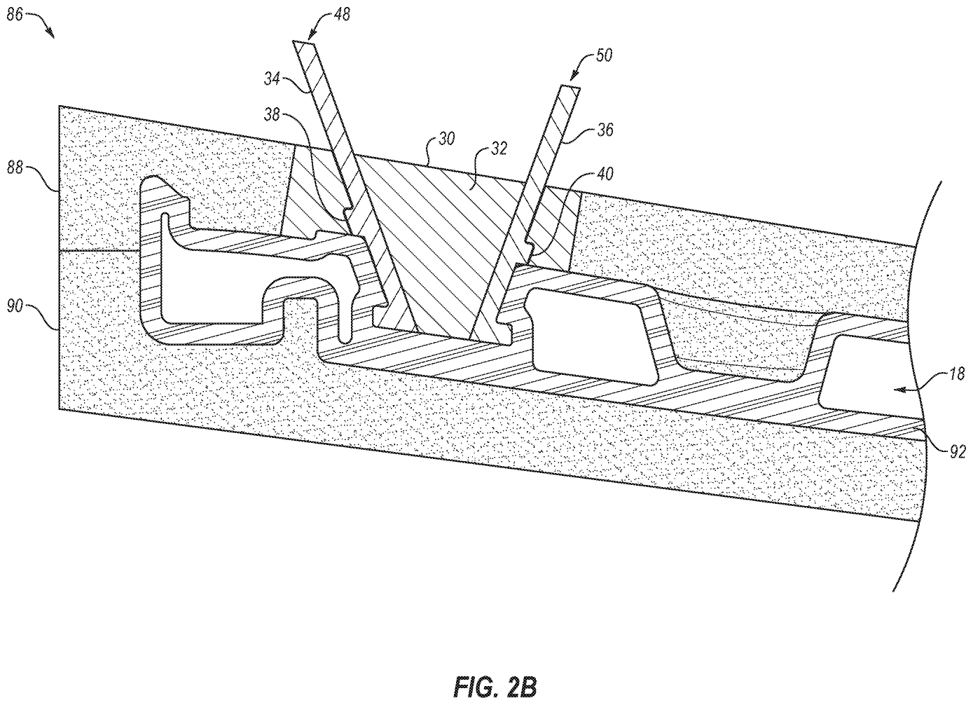

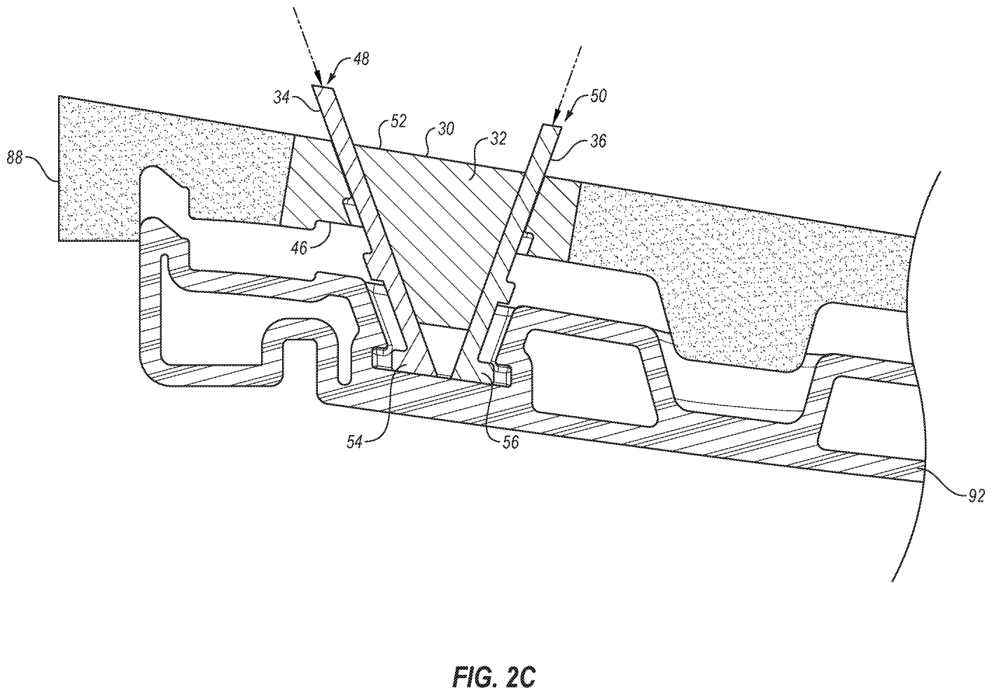

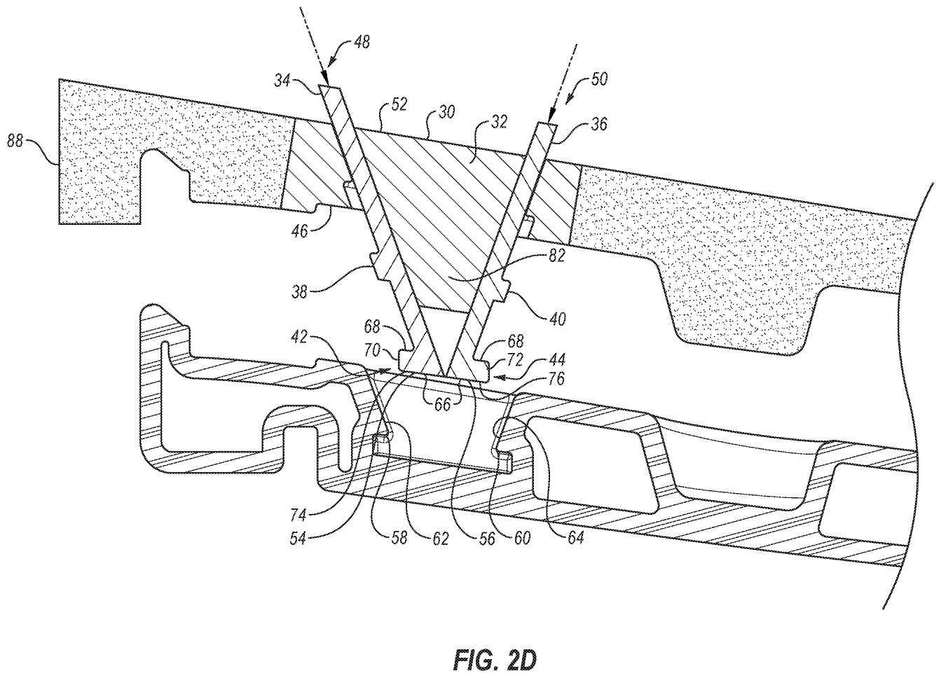

FIGS. 2A-2D illustrate another exemplary embodiment of a blow-molded plastic structure including an undercut. As shown in FIG. 2A, a tool 30 may be disposed or connected to a portion of a mold 86 and the tool may have a similar size, shape, configuration, and/or arrangement as one or more of the tools described herein. It will be appreciated that the tool 30 may have other suitable sizes, shapes, configurations, and/or arrangements depending, for example, upon the type or form of the blow-molded plastic structure. It will also be appreciated that the same reference numbers and/or wording may be used for readability and convenience, but the various embodiments may have other suitable sizes, shapes, configurations, and/or arrangements depending, for example, upon the type or form of the blow-molded plastic structure.

As shown in FIG. 2A, the tool 30 may be disposed in a molding position and the two halves 88, 90 of the mold 86 may be disposed in a closed position. As shown in FIG. 2B, a blow-molded plastic structure 92 may be formed in the mold 86 and the tool 30 may create at least a portion of the inwardly extending portion 24 and/or the undercut 26. As shown in FIG. 2C, one half of the mold 90 may be removed and the blow-molded plastic structure 92 may be partially removed or released from the other half of the mold 88. In addition, the tool 30 may be at least partially disposed in the release position. A device, such as a motor, cam, piston, driver, and the like, may be connected to one or more of the fingers 34, 36 and the device may move the fingers. For example, the device may move one or more of the fingers 34, 36 and the device may move the fingers between the molding and release positions. As shown in FIG. 2D, the tool 30 may be disposed in the release position and the blow-molded plastic structure 92 may be released from the mold 86 and the tool.

As shown in FIGS. 2A-2D, the fingers 34, 36 of the tool 30 may form the undercut 26 in the inwardly extending portion 24 of the blow-molded plastic structure 92 and the fingers of the tool may move to allow the blow-molded plastic structure to be released from the tool and/or the mold. Advantageously, the fingers 34, 36 may move at the same and/or similar rate as a device that ejects the blow-molded plastic structure 92 from the mold 86. This may allow, for example, the blow-molded plastic structure 92 to be ejected from the mold 86 concurrently with the tool 30 being released from the blow-molded plastic structure. In greater detail, the mold 86 may include one or more ejectors, such as ejector pins, that eject the blow-molded plastic structure 92 from the mold. The ejectors may push the blow-molded plastic structure 92 away from the face of the mold 86. The fingers 34, 36 of the tool 30 may move at the same or approximately the same time as the ejectors to allow the blow-molded plastic structure 92 to be released from the mold 86. For instance, the ejectors may push the blow-molded molded plastic structure 92 away from the mold 86 at the same general time as the fingers 34, 36 move from the molding position to the release position. It will be appreciated that the fingers 34, 36 and/or ejectors may individually or jointly push the blow-molded molded plastic structure 92 from the mold 86. The ejectors may push the blow-molded plastic structure 92 a greater distance away from the mold 86 than the distance from the mold to the distal ends 42, 44 of the fingers 34, 36 in the release position so that the fingers are no longer disposed in the inwardly extending portion 24. This may facilitate removal of the blow-molded plastic structure 92 manually or automatically, such as by a robot, from the mold.

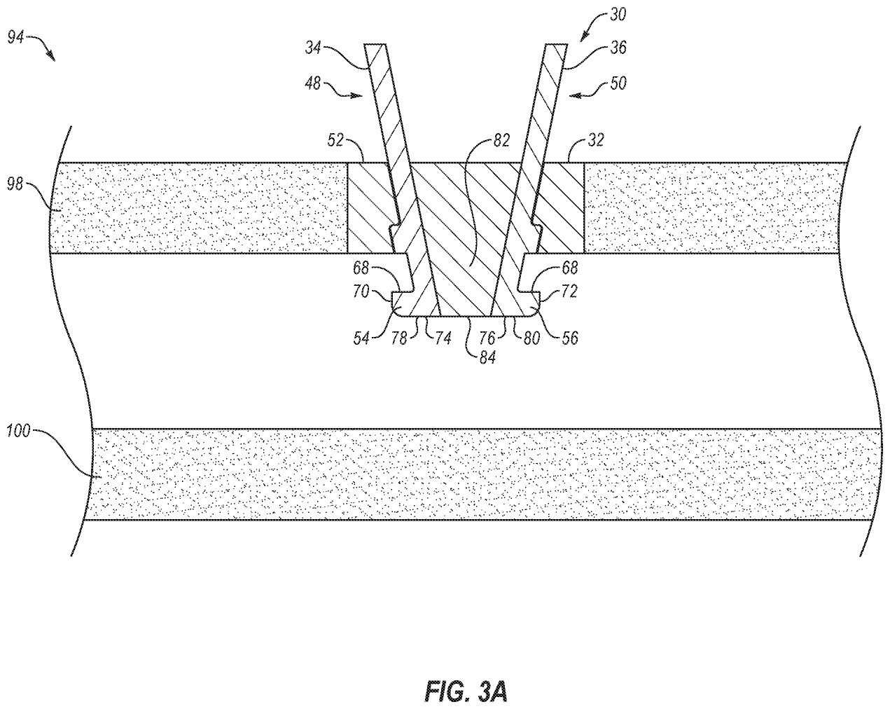

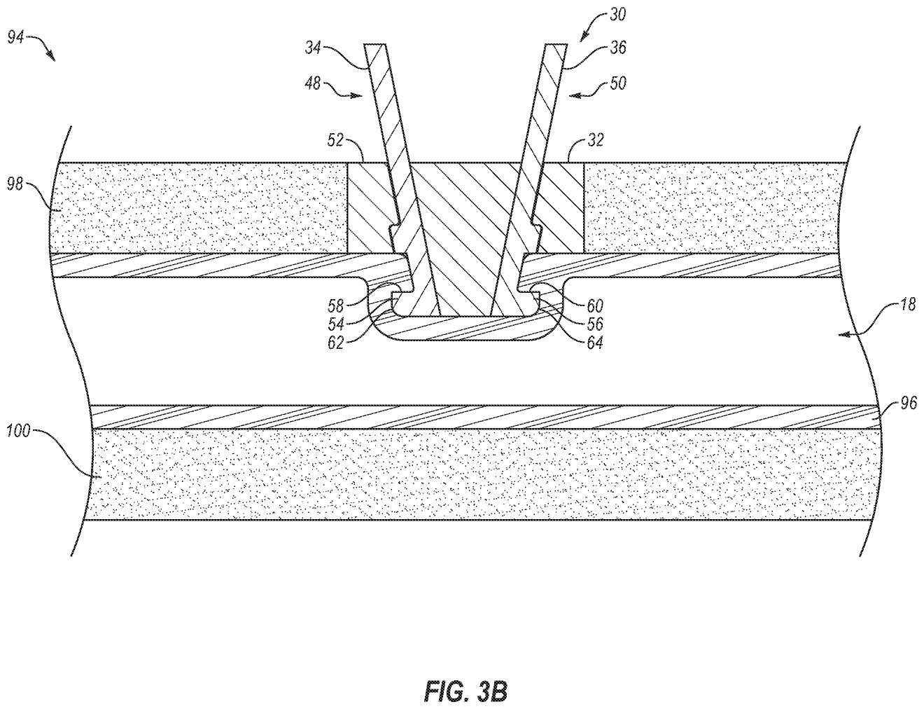

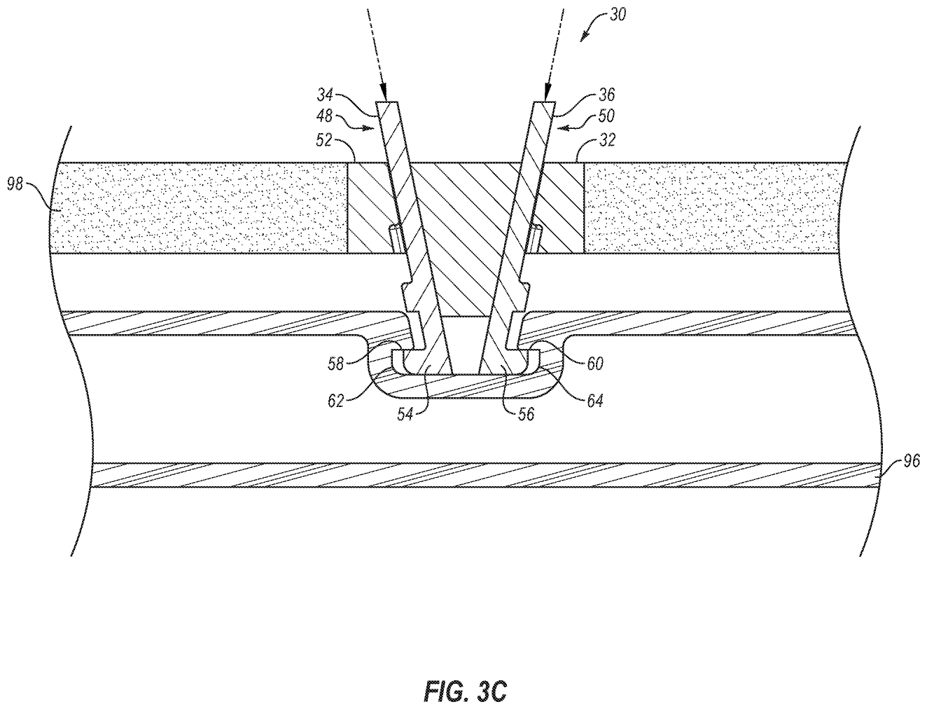

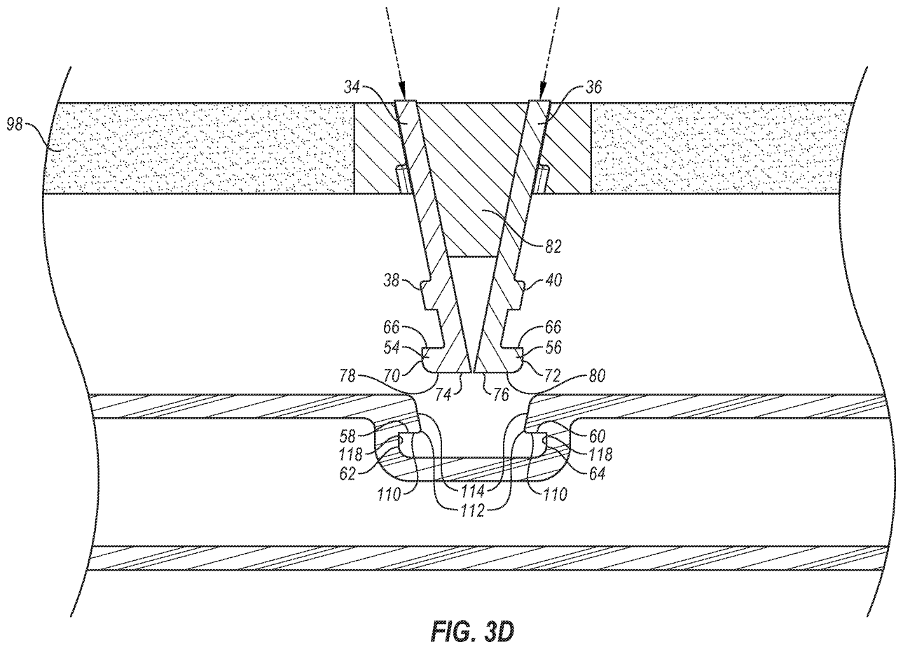

Another exemplary embodiment of a blow-molded plastic structure including an undercut is shown in FIGS. 3A-3D. As shown in FIG. 3A, a tool 30 may be disposed or connected to a portion of a mold 94 and the tool may have a similar size, shape, configuration, and/or arrangement as one or more of the tools described herein. The tool 30 may be disposed in a portion of the mold 94 and, as shown in FIG. 3A, the tool may be disposed in a molding position. As shown in FIG. 3B, a blow-molded plastic structure 96 may be formed in the mold 94 and the tool 30 may create at least a portion of the inwardly extending portion 24 and/or the undercut 26. As shown in FIG. 3C, one half of the mold 100 may be removed and the blow-molded plastic structure 96 may be partially removed or released from the other half of the mold 98. In addition, the tool 30 may be at least partially disposed in the release position. Because the fingers 34, 36 may be disposed at an angle, the distance separating the ends 70, 72 of the outwardly extending portions 54, 56 at the distal ends 42, 44 of the fingers may change as the tool 30 moves between the molding and release positions. For example, as shown in FIGS. 3A and 3B, the ends 70, 72 of the outwardly extending portions 54, 56 of the distal ends of the fingers may be spaced apart by a first distance D. As the fingers 34, 36 move from the molding position to the release position, the distance D between the outwardly extending portions 54, 56 of the distal ends 42, 44 of the fingers may decrease, as shown in FIG. 3C. As shown in FIG. 3D, the tool 30 may be disposed in the release position and the distance D between the outwardly extending portions 54, 56 at the distal ends 42, 44 of the fingers 34, 36 may be generally equal to or less than an opening 102 of the inwardly extending portion 24. This may allow the blow-molded plastic structure 96 with the undercut to be removed from the mold 94 and/or the tool 30. Significantly, this may allow the blow-molded plastic structure 96 to be removed from the mold 94 and/or the tool 30 without any deformation, or without any significant deformation, of the blow-molded plastic structure. For example, the blow-molded plastic structure 96 may be removed from the mold 94 and/or the tool 30 without the blow-molded plastic structure contacting the tool. The blow-molded plastic structure 96 may also be removed with the tool 30 contacting the structure but without the tool deforming the structure. In addition, the blow-molded plastic structure 96 may be removed with the tool 30 deforming a portion of the blow-molded plastic structure but the blow-molded plastic structure resiliently returning to its previous position, or at least substantially to its previous position, after the blow-molded plastic structure is removed.

For example, in an exemplary embodiment, a blow-molded plastic structure (such as the chair seat 10 and/or blow-molded plastic structures 92, 96) may include an inwardly extending portion, such as the inwardly extending portion 24, and an undercut, such as the undercut 26. As shown in the accompanying figures, an exemplary embodiment of the undercut, such as the first undercut 58 and the second undercut 60, may include a surface 110 and the surface may have a generally planar configuration. The undercuts 58, 60 may also include an edge or angled portion 112. The undercuts 58, 60 may be aligned and/or may include a portion of an inwardly extending portion, such as a wall or sidewall 114. The angled portion 112 may be disposed at an acute angle relative to the sidewall 114, which may form a sharp edge or corner. For instance the angled portion 112 may be disposed at an angle of generally equal to or less than about ninety degrees (90°), generally equal to or less than about eighty degrees (80°), generally equal to or less than about seventy degrees (70°), generally equal to or less than about sixty degrees (60°), generally equal to or less than about fifty degrees (50°), generally equal to or less than about forty degrees (40°), generally equal to or less than about thirty degrees (30°), generally equal to or less than about twenty degrees (20°), or generally equal to or less than about ten degrees (10°).

As shown in FIGS. 3A-3D, the fingers 34, 36 of the tool 30 may form one or more undercuts, such as the first undercut 58 and the second undercut 60, and one or more receiving portions 118 in the blow-molded plastic structure 96. The fingers 34, 36 of the tool 30 may move to allow the blow-molded plastic structure 96 to be released from the tool 30 and/or the tool to be released from the blow-molded plastic structure. As discussed above, the fingers 34, 36 may move at the same or similar rate as a device that ejects the blow-molded plastic structure 96 from the mold 94. This may allow, for example, the blow-molded plastic structure 96 to be ejected from the mold 94 concurrently with the tool 30 being released from the blow-molded plastic structure. Thus, in an embodiment that may include features similar to that disclosed in connection with FIGS. 2A-2D, the mold 94 may include one or more ejectors, such as ejector pins, that eject the blow-molded plastic structure 96 from the mold. The ejectors may push the blow-molded plastic structure 96 away from the face of the mold 94. The fingers 34, 36 of the tool 30 may move at the same or approximately the same time as the ejectors to allow the blow-molded plastic structure 96 to be released from the mold 94. For instance, the ejectors may push the blow-molded plastic structure 96 away from the mold 94 at the same general time as the fingers 34, 36 move from the molding position to the release position. It will be appreciated that the fingers 34, 36 and ejectors may individually or jointly push the blow-molded plastic structure 96 from the mold 94. The ejectors may push the blow-molded plastic structure 96 a greater distance away from the mold 94 than the distance from the mold to the distal ends 42, 44 of the fingers 34, 36 in the release position so that the fingers are no longer disposed in the inwardly extending portion. This may facilitate removal of the blow-molded plastic structure 96 manually or automatically from the mold 94.

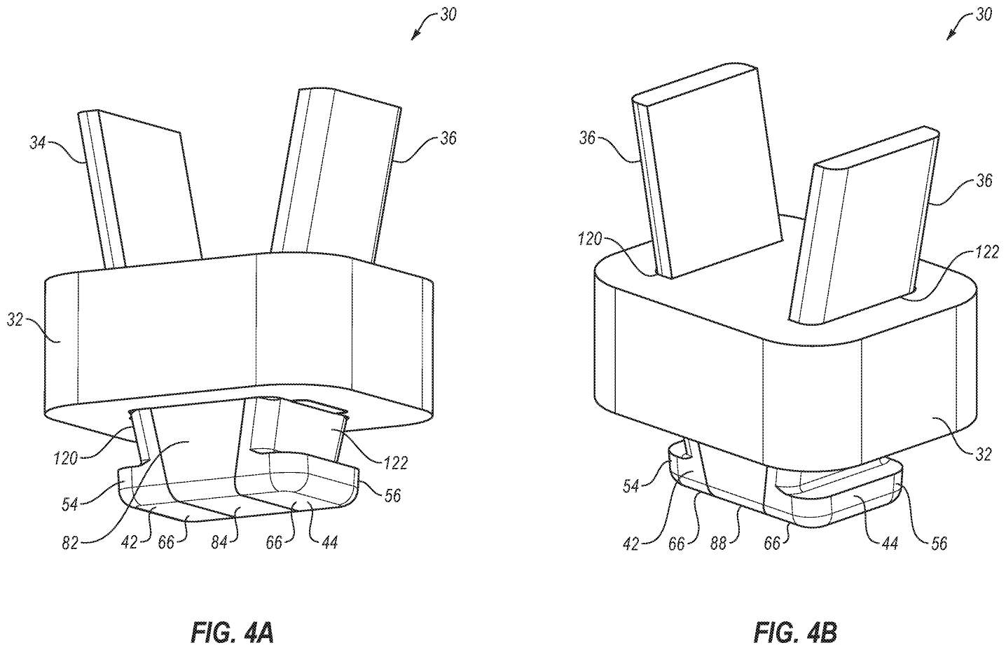

FIGS. 4A and 4B show an exemplary embodiment of a tool 30 in a molding position. The tool 30, which may have a similar size, shape, configuration, and/or arrangement to the tools described herein, and the tool may include a base 32 and one or more fingers 34, 36. The base 32 may include one or more guides or pathways 120, 122 that facilitate and/or control movement of the fingers 34, 36 relative to the base 32. The fingers 34, 36 may include an end, such as the distal ends 42, 44, and an outwardly extending portion, such as the outwardly extending portions 54, 56, may be disposed at least proximate the end of the finger. As shown in the accompanying figures, an upper surface, such as the surface 66, of the fingers 32, 34 may be generally aligned and disposed in the same plane when the tool 30 is in the molding position. In addition, the upper surfaces, such as the surfaces 66, of the fingers 32, 34 may be generally aligned and disposed in the same plane as a portion of the base 32, such as the upper surface 84 of a generally wedge-shaped guide 82. The upper surface 46 of the base 32, the ends of the fingers 34, 36, the outwardly extending portions 54, 56, and/or the generally wedge-shaped guide 82 may form one or more molding surfaces that are used to mold the plastic into the desired shape during the blow-molding process.

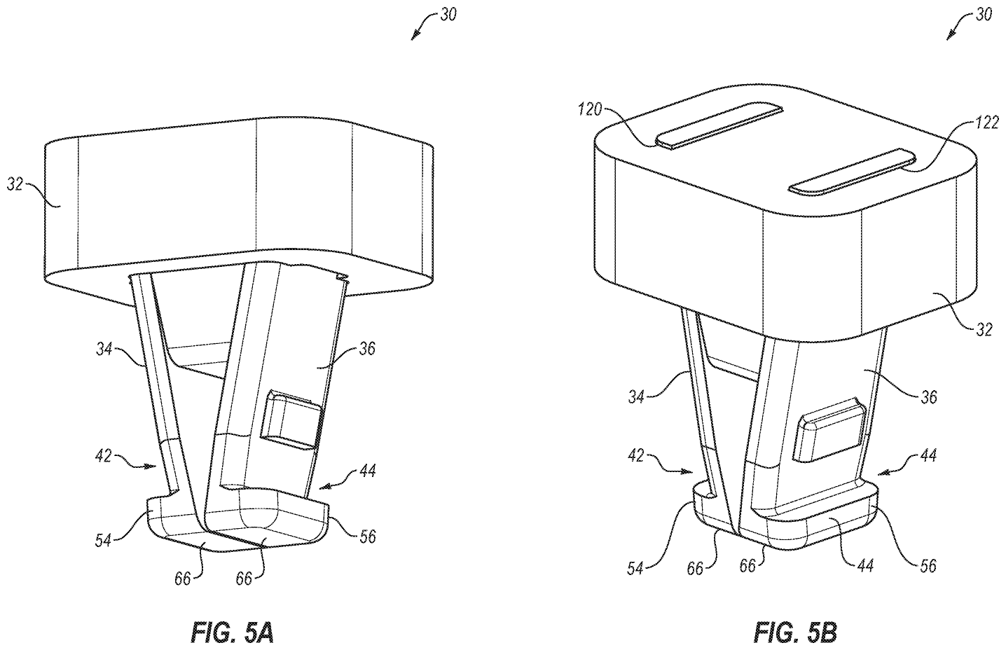

FIGS. 5A and 5B show an exemplary embodiment of a tool 30 in a release position. The tool 30, which may have a similar size, shape, configuration, and/or arrangement to the tools described herein, may include a base 32 and one or more fingers 34, 36. The base 32 may include guides or pathways 120, 122 that facilitate and/or control movement of the fingers 34, 36 relative to the base 32. The fingers 34, 36 may include an end, such as the distal ends 42, 44, and an outwardly extending portion, such as the outwardly extending portions 54, 56, may be disposed at least proximate the end of the finger. As shown in the accompanying figures, an upper surface, such as the surface 66, of the fingers 32, 34 may be generally aligned and disposed in the same plane when the tool 30 is in the release position. In addition, the ends, such as the distal ends 42, 44, of the fingers 34, 36, may contact or touch in the release position. The ends of the fingers 34, 36, however, may be spaced apart in the release position.

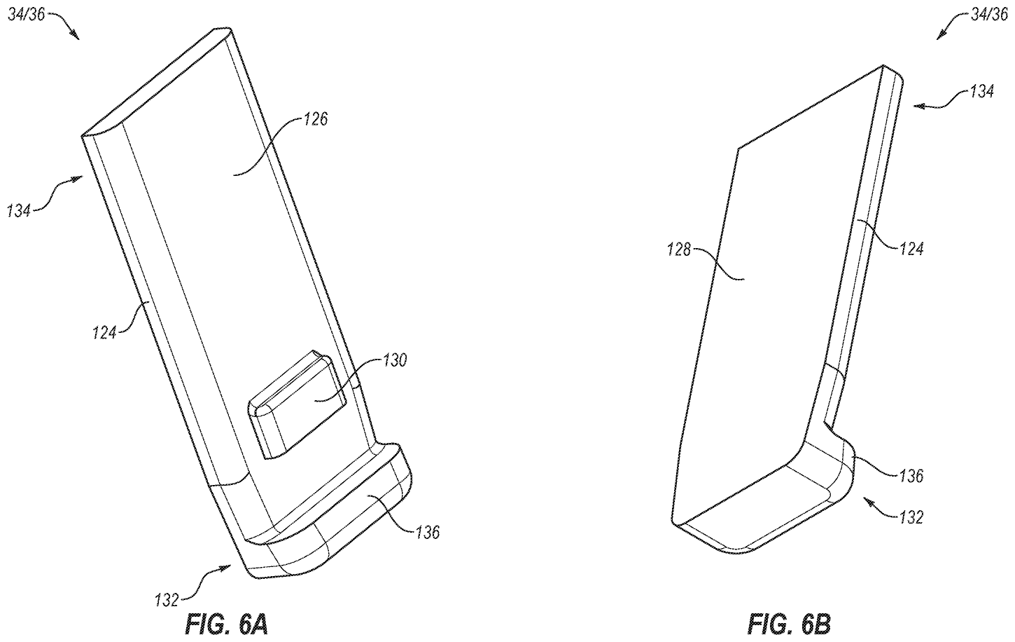

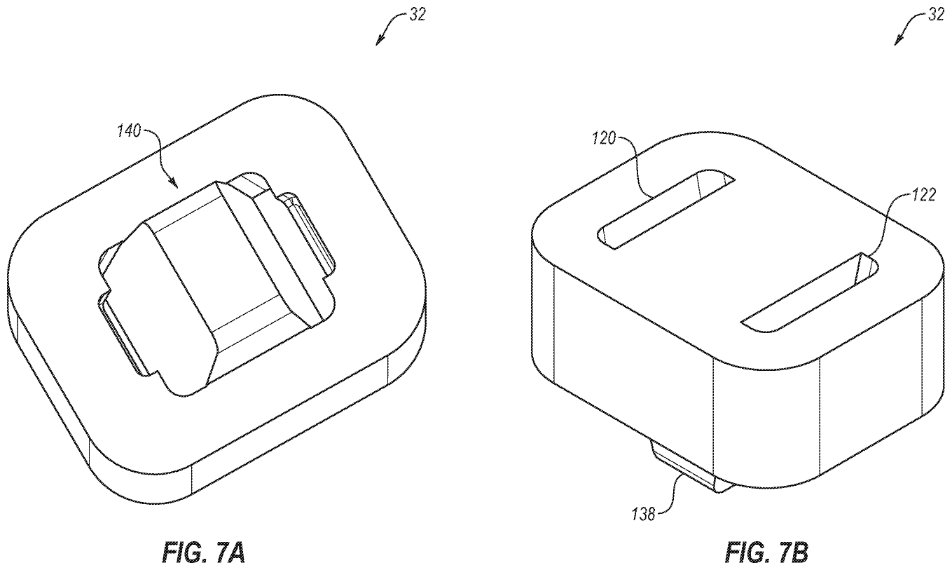

FIGS. 6A and 6B show an exemplary embodiment of a finger, such as the finger 34 and/or 36, that may be part of a tool 30 and the tool may have a similar size, shape, configuration, and/or arrangement to the tools described herein. The finger 34, 36, may include an elongated body 124 with an inner surface 126 and an outer surface 128. The finger 34, 36 may include a stop 130 and the stop may help control movement of the finger. For example, the stop 130 may help position the finger 34, 36 in the molding position and/or the release position. The finger 34, 36 may include more than one stop 130, which may help position the fingers in the molding position and/or the release position. The finger 34, 36 may include an end 132, which may be referred to as a distal end, and an opposing end 134, which may be referred to as a proximal end. An outwardly extending portion 136 may be disposed at least proximate an end of the finger 34, 36, such as the distal end 132. For example, as shown in the accompanying figures, the outwardly extending portion 136 and/or the stop 130 may be disposed towards or on the distal end 132 of the finger 34, 36. It will be appreciated that the stop 130 and the outwardly extending portion 136 may be disposed on different surfaces and the stop and the outwardly extending portion may not be required.

FIGS. 7A and 7B show an exemplary embodiment of a base, such as the base 32, that may be part of a tool 30 and the tool may have a similar size, shape, configuration, and/or arrangement to the tools described herein. The base 32 may include a first guide, such as the pathway or opening 120, and a second guide, such as the pathway or opening 120. The first guide 120 may help control movement of a first finger, such as the finger 34, relative to the base 32 and the second guide 122 may help control movement of a second finger, such as the finger 36, relative to the base. The base 32 may include an outwardly extending projection 138, which may also be a guide and/or may form part of the first guide 120 and/or the second guide 122, and the outwardly extending projection may have a generally wedge-shaped configuration. The base 32 may include an inwardly extending projection 140, which may also be a guide and/or may form part of the first guide 120 and/or the second guide 122, and the inwardly extending projection may have a generally wedge-shaped configuration. The guides 120, 122 may be sized and configured to allow the fingers 34, 36 to move between one or more positions relative to the base 32, such as a molding position and a release position.

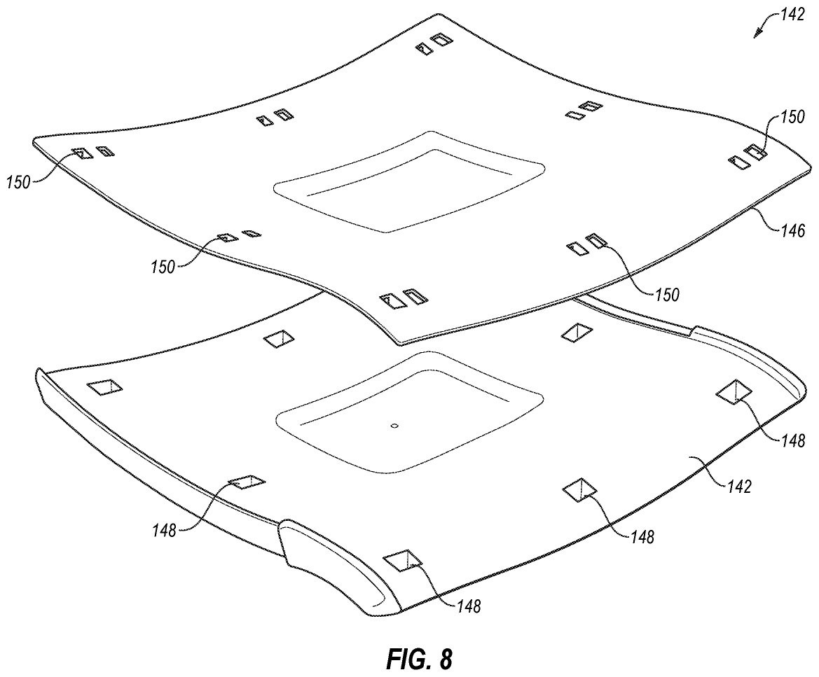

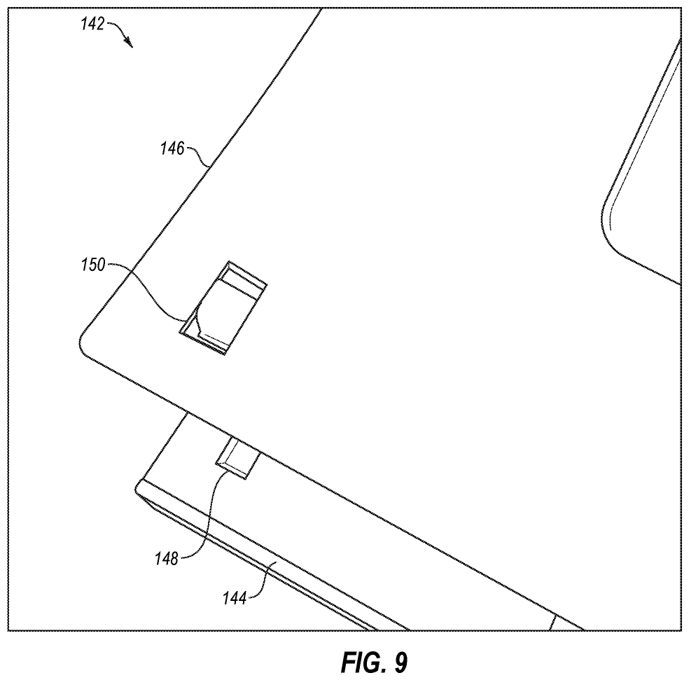

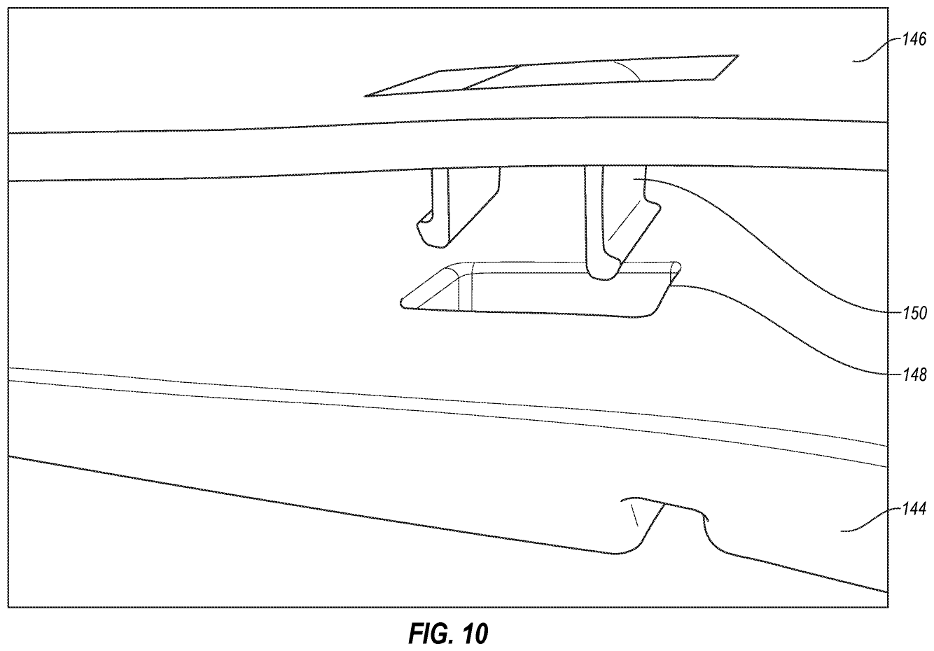

FIGS. 8-10 show an exemplary embodiment of a structure, or a portion of a structure, that may be constructed from blow-molded plastic. For example, the structure may be a chair and a portion of the chair may be constructed from blow-molded plastic. In particular, a portion of the chair, such as a chair seat 142, may be constructed from blow-molded plastic. The chair seat 142, for example, may including a base portion 144 constructed from blow-molded plastic and a structure, such as a chip or clip 146, that may be connected to the blow-molded plastic base. The blow-molded plastic base 144 may include a plurality of inwardly receiving portions 148 with an undercut and the chip 146 may include a plurality of engaging portions 150 that are sized and configured to be inserted into the inwardly receiving portions 148. Advantageously, the undercuts in the inwardly receiving portions 148 may allow the chip 146 to be securely connected to the blow-molded plastic base 144. The chip 146 may be used to attached cushioning, covering, and the like to the chair seat 142.

A blow-molded plastic structure including an inwardly extending receiving portion with an undercut may be formed as part of a process or method. For example, the blow-molded plastic structure with an undercut may be created as part of a production method. The method may include producing or manufacturing any suitable number of blow-molded plastic structures with an undercut. The undercut may be contemporaneously formed during the process or method, and the undercut may be integrally formed as part of a unitary, one-piece structure during the process or method.

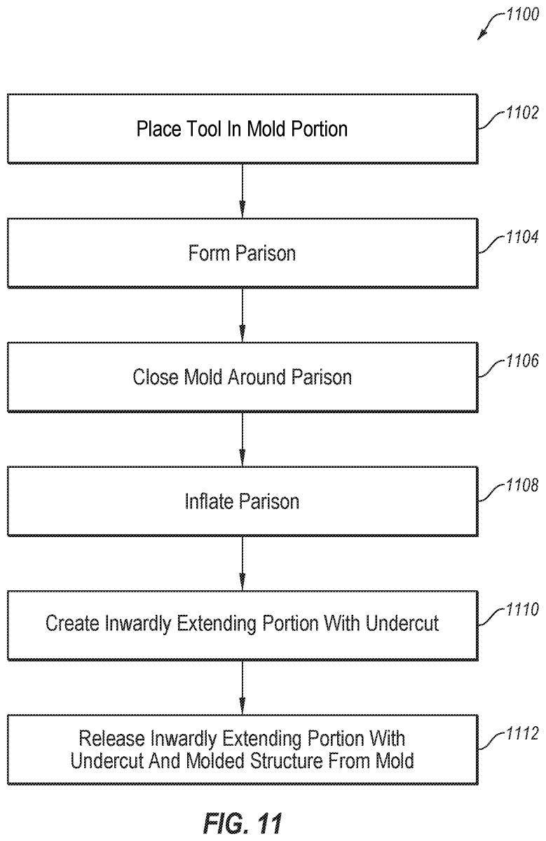

As shown in FIG. 11, an exemplary production method for a blow-molded plastic structure with an inwardly extending receiving portion and an undercut is denoted at 1100. The method 1100 may begin by placing or attached a tool, such as a tool disclosed herein, to a portion of a mold 1102. A parison of melted plastic may be formed 1104, and the parison may be disposed in the mold. The parison may be formed by extruding the plastic through a die or other known means. The mold may be closed around the parison 1106. The parison may be inflated 1108 with a gas, such as pressurized air, and at least a portion of the plastic may come into at least substantial contact with some, or all, interior portions of the mold and the outer portions of the tool while the tool is in the molding position. The tool may create the inwardly extending portion with the undercut 1110. After the blow-molded plastic structure has been created, the inwardly extending portion with the undercut and the molded plastic structure may be released from the mold 1112. For example, in an exemplary embodiment, the blow-molded plastic structure may be ejected from the mold by one or more ejector pins. Simultaneously, the tool may move from the molding position to the release position. Thus, ejection of the blow-molded plastic structure from the mold and movement of the tool from the molding position to the release position may happen concurrently. The blow-molded plastic structure may be ejected from the mold at substantially the same time and/or rate as the tool moves from the molding position to the release position. This may allow simultaneous release of the blow-molded plastic structure from the mold and the release of the tool from the undercut, which may facilitate the production process.

Structures constructed from blow-molded plastic may have unique and distinctive properties, and some aspects of blow-molding may not be compatible with other types of molding such as injection molding, rotational molding, vacuum fuming, and the like. For example, because a blow-molded plastic structure is formed by using air or gas to inflate a parison of molten plastic, some features or structures that can be made from some types of molding processes cannot be manufactured using known blow-molding techniques. In addition, a blow-molded plastic structure is generally formed with an outer surface of the structure engaging the face of the mold and a hollow interior that is filled with pressurized gas during the molding process. Thus, blow-molded plastic structures may not be manufactured with the devices, molds, structures, and the like of other types of molding processes because of the different properties and configurations of blow-molded plastic structures. Further, because most blow-molded plastic structures include opposing walls separated by a distance and enclosing a hollow interior portion, processes or structures that may work with a single layer of material may not work with a blow-molded structure. Accordingly, after reviewing this disclosure, one skill in the art will appreciate the significant differences between the blow-molded plastic structures and methods disclosed herein, and other types of molded plastic structures and methods.

One of ordinary skill in the art may appreciate after reviewing this disclosure that the chair seat and structures disclosed herein may have a number of different aspects, features, characteristics and configurations. Further, chair seat and structures may have any suitable number of aspects, features, characteristics and configurations depending, for example, upon the intended use of the chair or other structure.

One of ordinary skill will appreciate that the structures disclosed herein may have various suitable sizes, shapes, configurations, and/or arrangements. Other exemplary configurations are shown below:

Although this invention has been described in terms of certain preferred embodiments, other embodiments apparent to those of ordinary skill in the art are also within the scope of this invention. Accordingly, the scope of the invention is intended to be defined only by the claims which follow.

What is claimed is:

1. A blow-molded plastic structure constructed using a blow-molding process, the blow-molded plastic structure comprising:
an outer surface of the blow-molded plastic structure;
an inwardly extending portion disposed in the outer surface; and
an undercut disposed in the inwardly extending portion.

2. The blow-molded plastic structure of claim 1, wherein the undercut comprises a surface and an angled portion relative to the surface, the angled portion being disposed at an acute angle relative to the surface, the angled portion forming an edge of the undercut.

3. The blow-molded plastic structure of claim 1, wherein the undercut forms a portion of a receiving portion.

4. The blow-molded plastic structure of claim 1, wherein a receiving portion is formed between an upper surface of the undercut and an upper surface of the inwardly extending portion.

5. The blow-molded plastic structure of claim 1, wherein the outer surface, the inwardly extending portion, and the undercut are integrally formed as part of a unitary, one-piece structure during the blow-molding process.

6. A method of manufacturing a blow-molded plastic structure, the method comprising:
placing a tool in a portion of a mold for blow-molding a plastic structure;
forming a parison of molten plastic;
disposing the parison of molten plastic in the mold;
closing the mold around the parison of molten plastic;
inflating the parison; and
creating an inwardly extending portion with an undercut with the tool.

7. The method of claim 6, further comprising releasing the inwardly extending portion with the undercut from the tool by moving the tool from a molding position to a release position.

8. The method of claim 6, further comprising concurrently releasing the molded plastic structure from the mold and releasing the inwardly extending portion with the undercut from the tool.

9. The method of claim 6, further comprising creating a receiving portion disposed between an upper surface of the undercut and an upper surface of the inwardly extending portion.

10. The method of claim 6, further comprising creating an edge of the undercut, the edge being disposed at an acute angle relative to a surface of the undercut, the acute angle being:
less than about sixty degrees (60°);
less than about fifty degrees (50°);
less than about forty degrees (40°);
less than about thirty degrees (30°);
less than about twenty degrees (20°); or
less than about ten degrees (10°).

11. A tool used to create an undercut in a blow-molded plastic structure constructed using a blow-molded process, the tool comprising:
a base;
a first guide at least partially disposed in the base;
a second guide at least partially disposed in the base;
a first finger at least partially disposed in the first guide, the first finger being movable relative to the base between a molding position and a release position, the first finger including an elongated body and an outwardly extending portion; and
a second finger at least partially disposed in the second guide, the second finger being movable relative to the base between a molding position and a release position, the second finger including an elongated body and an outwardly extending portion.

12. The tool of claim 11, wherein when the first finger and the second finger are disposed in the molding position, an upper surface of the outwardly extending portion of the first finger and an upper surface of the outwardly extending portion of the second finger are generally aligned in the same plane; and
wherein when the first finger and the second finger are disposed in the release position, the upper surface of the outwardly extending portion of the first finger and the upper surface of the outwardly extending portion of the second finger are generally aligned in the same plane.

13. The tool of claim 11, wherein when the first finger and the second finger are disposed in the molding position, an upper surface of the outwardly extending portion of the first finger and an upper surface of the outwardly extending portion of the second finger are disposed a first distance from the base; and
wherein when the first finger and the second finger are disposed in the release position, the upper surface of the outwardly extending portion of the first finger and the upper surface of the outwardly extending portion of the second finger are disposed a second distance from the base, the second distance being greater than the first distance.

14. The tool of claim 11, wherein the first finger moves along a first axis that is disposed at an angle relative to the base and the second finger moves along a second axis that is disposed at an angle relative to the base;
wherein the angle of the first axis relative to the base is generally the same as the angle of the second axis relative to the base.

15. The tool of claim 11, wherein the outwardly extending portion of the first finger is disposed a first distance from the outwardly extending portion of the second finger when the first finger and the second finger are in the molding position;
wherein the outwardly extending portion of the first finger is disposed a second distance from the outwardly extending portion of the second finger when the first finger and the second finger are in the release position; and
wherein the second distance is smaller than the first distance to allow the outwardly extending portion of the first finger and the outwardly extending portion of the second finger to be removed from the undercut formed in the blow-molded plastic structure.
